(19) United States
(12) Patent Application Publication
(10) Pub. No.: US 2004/0153844 A1
(43) Pub. Date: Aug. 5, 2004

(54) Failure analysis method and system for storage area networks

(76) Inventors: Gautam Ghose, San Jose, CA (US); Chandra Prasad, Los Altos, CA (US); Richard Meyer, San Francisco, CA (US); Rush Manbert, San Jose, CA (US)

Correspondence Address: Law Office Of Leland Wiesner, 1144 Fife Ave., Palo Alto, CA, 94301, US

(21) Appl. No.: 10/695,889

(22) Filed: Oct. 28, 2003

Related U.S. Application Data
(60) Provisional application No. 60/422,109, filed on Oct. 28, 2002.

(51) Int. Cl. H04B 1/74

(52) U.S. Cl. 714/42

(57) ABSTRACT

A method and system for configuring a storage virtualization controller to manage errors in a storage area network includes identifying predetermined error actions and error events associated with the storage area network, specifying an error pattern based upon a combination of error events and associating an error action to perform in response to receiving the combination of error events of the error pattern. In addition, managing the occurrence of errors generated in a storage area network includes generating error events responsive to the occurrence of the conditions of components being monitored in the storage area network, receiving the error events over a time interval for analysis in a failure analysis module, comparing the temporal arrangement of the error events received against a set of error patterns loaded in the failure analysis module and identifying and performing the error action(s) corresponding to the error pattern(s) that match as a result of the comparison.

### CROSS-REFERENCE TO RELATED APPLICATIONS

This application claims priority to U.S. Provisional Application No. 60/422,109, filed Oct. 28, 2002 and titled “Apparatus and Method for Enhancing Storage Processing in a Network-Based Storage Virtualization System”, which is incorporated herein by reference. This application also relates to the subject matter disclosed in the co-pending U.S. application Ser. No. ______ (attorney docket 00121-000600000, by Richard Meyer, et al., titled “Method and System for Dynamic Expansion and Contraction of Nodes in a Storage Area Network”, co-pending U.S. application Ser. No. ______ (attorney docket 00121-0007000000, by Gautam Ghose, et al., titled “Failure Analysis Method and System for Storage Area Networks”, co-pending U.S. application Ser. No. ______ (attorney docket 00121-0008000000, by Tuan Nguyen, et al., titled “Method and System for Managing Time-Out Events in a Storage Area Network”, co-pending U.S. application Ser. No. ______ (attorney docket 00121-0009000000, by Rush Manbert, et al., titled “Method and System for Strategy Driven Provisioning of Storage in a Storage Area Network”, filed concurrently herewith.

### BACKGROUND OF THE INVENTION

Storage area networks, also known as SANs, facilitate sharing of storage devices with one or more different host server computer systems and applications. Fibre channel switches (FCSs) can connect host servers with storage devices creating a high speed switching fabric. Requests to access data pass over this switching fabric and onto the correct storage devices through logic built into the FCS devices. Host servers connected to the switching fabric can quickly and efficiently share blocks of data stored on the various storage devices connected to the switching fabric.

Storage devices can share their storage resources over the switching fabric using several different techniques. For example, storage resources can be shared using storage controllers that perform storage virtualization. This technique can make one or more physical storage devices, such as disks, which comprise a number of logical units (sometimes referred to as “physical LUNs”) appear as a single virtual logical unit or multiple virtual logical units, also known as VLUNs. By hiding the details of the numerous physical storage devices, a storage virtualization system having one or more such controllers advantageously simplifies storage management between a host and the storage devices. In particular, the technique enables centralized management and maintenance of the storage devices without involvement from the host server.

In many instances it is advantageous to place the storage virtualization controller(s) in the middle of the fabric, with the host servers and controllers arranged at the outer edges of the fabric. Such an arrangement is generally referred to as a symmetric, in-band, or in-the-data-path configuration. Given the complexity of these systems, it is difficult to identify errors and failures in the SAN with a degree of certainty. It is also important to take remedial actions when these events occur if high availability and robust storage system characteristics are to be maintained. Unfortunately, it remains difficult to identify the source of errors and failures in modern SAN systems and act quickly enough to prevent system failures and lost data.

For these and other reasons, there is a need for the present invention.

### BRIEF DESCRIPTION OF THE DRAWINGS

The features of the present invention and the manner of attaining them, and the invention itself, will be best understood by reference to the following detailed description of embodiments of the invention, taken in conjunction with the accompanying drawings, wherein:

FIG. 1 is an exemplary system block diagram of the logical relationship between host servers, storage devices, and a storage area network (SAN) implemented using a switching fabric along with an embodiment of the present invention;

FIG. 2 is an exemplary system block diagram illustrative of the relationship provided by a storage virtualization controller between virtual logical units and logical units on physical storage devices, in accordance with an embodiment of the present invention;

FIG. 3A provides a schematic block diagram in virtualization storage controller for tracking system error events using a failure analysis module in accordance with one embodiment of the present invention;

FIG. 3B provides another schematic block diagram for tracking input-output error events by a failure analysis module in virtualization storage controller in accordance with one embodiment of the present invention;

FIG. 4 is a schematic diagram illustrating a combination of system error events and input-output error events and their processing in accordance with one implementation of the present invention;

FIG. 5 is a flowchart diagram providing the operations for configuring implementations of the present invention to manage errors in the storage virtualization controller;

FIG. 6 is a flowchart diagram for managing errors generated in a storage area network in accordance with implementations of the present invention;

FIG. 7 is a block diagram providing a portion of the object-oriented classes and methods used to implement the error analysis and management of the present invention;

FIG. 8 is a block diagram of additional classes associated with one implementation of the present invention for creating error patterns;

FIG. 9 are block diagrams of additional object-oriented classes used to further define an “ErrorRule” class in accordance with one implementation of the present invention; and

FIG. 10 provides one implementation of the present invention as it would be implemented in a computer device or system.

### SUMMARY OF THE INVENTION

In one embodiment, the present invention provides a method for configuring a storage virtualization controller to manage errors in a storage area network. The configuration operation includes identifying one or more predetermined error actions and one or more error events associated with the storage area network, specifying an error pattern based upon a combination of one or more error events in the storage area network; and associating an error action to perform in response to receiving the combination of one or more error events of the error pattern.

In another embodiment, the present invention method of managing the occurrence of errors generated in a storage area network. The management operations include generating one or more error events responsive to the occurrence of one or more conditions of components being monitored in the storage area network, receiving the one or more error events over a time interval for analysis in a failure analysis module, comparing a temporal arrangement of the error events received against a set of error patterns loaded in the failure analysis module and identifying the error pattern from the set of error patterns and the error action corresponding to the error pattern to perform in response to the comparison in the failure analysis module.

### DETAILED DESCRIPTION

Aspects of the present invention provide an error and failure analysis and management facility for distributed storage controllers directing the storage and retrieval of information in a storage area network (SAN) environment. This error and failure analysis and management facility is advantageous for at least one or more of the following reasons described herein. The error and failure analysis is performed on a centralized failure analysis module even though the errors or other alerts come from distributed storage controllers and storage systems. Different errors and failures occurring on many different subsystems in the SAN or on the storage controllers can be analyzed more readily on the centralized failure analysis module. This information can be used to rapidly identify failing systems and take actions to ameliorate the damage or loss of data. For example, the centralized failure analysis module can direct various distributed storage controllers performing storage virtualization to relocate data from failing storage systems to more reliable storage systems. Many other types of recovery operations can take place by way of the centralized failure analysis module.

Further, another advantage of the present invention provides opportunities for backup systems to take over processing in the event a centralized failure analysis module is abruptly shutdown or fails. In a SAN having a distributed set of storage controllers, one storage controller can be designated as housing the primary failure analysis module while other storage controllers can be designated to hold the secondary or tertiary failure analysis modules in the event of a storage controller or failure analysis module becoming unavailable or down.

Yet another advantage of the present invention allows rapid generation of error rules to govern the detection and management of errors and failures in the storage area network. Rule-driven or policy based error rules can be generated without additional code using a set of predetermined error events and error actions. These error events are assembled into error rules and associated with error actions through a non-programmatic interface. For example, a SAN administrator can setup the error management system of the present invention through a graphical user interface (GUI). The GUI interfaces with object-oriented methods and instances according to the configuration information thereby making the system easier to use and deploy. Further, rules can be developed incrementally and over time as problems on the SAN arise and are understood without having to re-code or throw away previous work setting up the error and failure analysis and management. This allows implementations of the present invention to grow and change with changing use of the SAN.

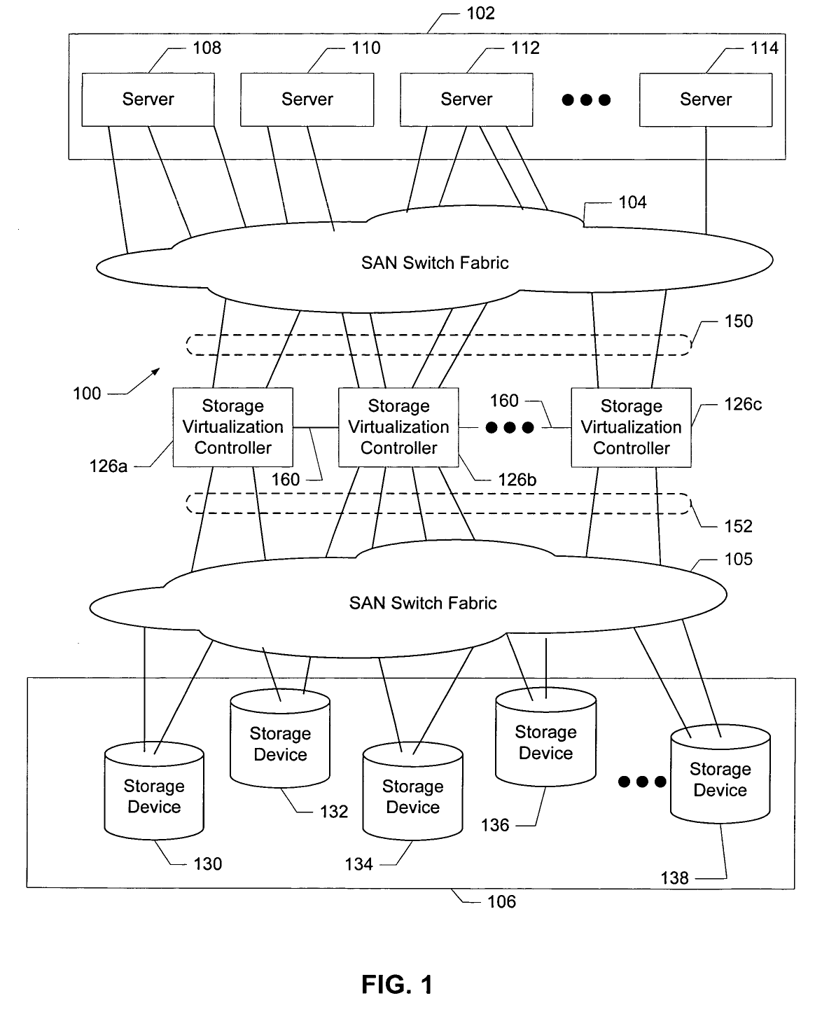

Referring to the exemplary configuration in FIG. 1, a storage area network (SAN) 100 may include one or more SAN switch fabrics, such as fabrics 104,105. Fabric 104 is connected to hosts 102, while fabric 105 is connected to storage devices 106. At least one storage virtualization controller 126 is inserted in the midst of SAN 100, and connected to both fabrics 104,105 to form a symmetric, in-band storage virtualization configuration. In an in-band configuration, communications between server devices 102 and storage devices 106 pass through controller 126 for performing data transfer in accordance with the present invention.

Host servers 102 are generally communicatively coupled (through fabric 104) via links 150 to individual UPEs of controller 126. In an alternate configuration, one or more host servers may be directly coupled to controller 126, instead of through fabric 104. Controller 126 includes at least one UPE for each server 102 (such as host servers 108,110,112,114) connected to the controller 126. As will be discussed subsequently in greater detail, storage virtualization controller 126 appears as a virtual logical unit (VLUN) to each host server.

Storage devices 106 are communicatively coupled (through fabric 105) via links 152 to individual downstream processing elements (DPEs) of controller 126. In an alternate configuration, one or more storage devices may be directly coupled to controller 126, instead of through fabric 105. Controller 126 includes at least one DPE for each storage device 106 (such as storage devices 130,132,134,136,138) connected to the controller 126. Controller 126 appears as an initiator to each storage device 106. Multiple controllers 126 may be interconnected by external communications link 160. Within each controller 126 are separate failure analysis modules designed in accordance with the present invention along with supporting hardware and software needed to implement the present invention. As described later herein, these failure analysis modules perform centralized error analysis and management yet can also be configured to provide high-availability and reliability through a fail-over/backup configuration scheme.

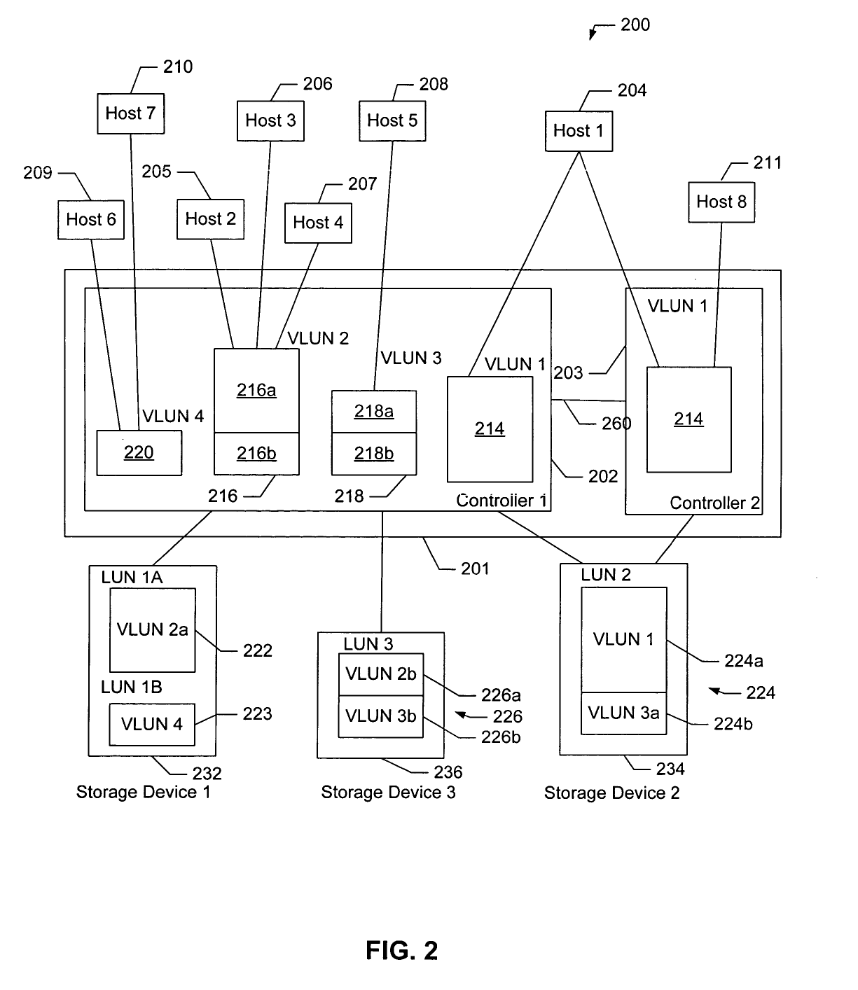

Considering now the virtualization of storage provided by an embodiment of the present invention, and with reference to the exemplary SAN 200 of FIG. 2, a storage virtualization system includes an exemplary storage virtualization controller arrangement 201. Controller arrangement 201 includes, for illustrative purposes, two storage virtualization controllers 202,203 interconnected via communication link 260. Controller1 202 has been configured to provide four virtual logical units 214,216,218,220 associated with hosts 204-210, while controller2 203 has been configured to provide one virtual logical unit 214 associated with hosts 204,211. In the general case, a virtual logical unit (VLUN) includes N “slices” of data from M physical storage devices, where a data “slice” is a range of data blocks. In operation, a host requests to read or write a block of data from or to a VLUN. Through controller1 202 of this exemplary configuration, host1 204 is associated with VLUN1 214; host2 205, host3 206, and host4 207 are associated with VLUN2 216; host5 208 and host6 209 are associated with VLUN3 218, and host7 210 is associated with VLUN4 220. Through controller2 203, host1 204 and host8 211 are also associated with VLUN1 214. It can be seen that host1 204 can access VLUN1 214 through two separate paths, one through controller1 202 and one path through controller2 203.

A host 204-211 accesses it's associated VLUN by sending commands to the controller arrangement 201 to read and write virtual data blocks in the VLUN. Controller arrangement 201 maps the virtual data blocks to physical data blocks on individual ones of the storage devices 232,234,236, according to a preconfigured mapping arrangement. Controller arrangement 201 then communicates the commands and transfers the data blocks to and from the appropriate ones of the storage devices 232,234,236. Each storage device 232,234,236 can include one or more physical LUNs; for example, storage device 1 232 has two physical LUNs, LUN 1A 222 and LUN 1B 223.

To illustrate further the mapping of virtual data blocks to physical data blocks, all the virtual data blocks of VLUN1 214 are mapped to a portion 224a of the physical data blocks LUN2 224 of storage device 234. Since VLUN2 216 requires more physical data blocks than any individual storage device 232,234,236 has available, one portion 216a of VLUN2 216 is mapped to the physical data blocks of LUN1A 222 of storage device 232, and the remaining portion 216b of VLUN2 216 is mapped to a portion 226a of the physical data blocks of LUN3 226 of storage device 236. One portion 218a of VLUN3 218 is mapped to a portion 224b of LUN2 224 of storage device 234, and the other portion 218b of VLUN3 218 is mapped to a portion 226b of LUN3 226 of storage device 236. It can be seen with regard to VLUN3 that such a mapping arrangement allows data block fragments of various storage devices to be grouped together into a VLUN, thus advantageously maximizing utilization of the physical data blocks of the storage devices. All the data blocks of VLUN4 220 are mapped to LUN1B 223 of storage device 232.

While the above-described exemplary mapping illustrates the concatenation of data block segments on multiple storage devices into a single VLUN, it should be noted that other mapping schemes, including but not limited to striping and replication, can also be utilized by the controller arrangement 201 to form a VLUN. Additionally, the storage devices 232,234,236 may be heterogeneous; that is, they may be from different manufacturers or of different models, and may have different storage sizes, capabilities, architectures, and the like. Similarly, the hosts 204-210 may also be heterogeneous; they may be from different manufacturers or of different models, and may have different processors, operating systems, networking software, applications software, capabilities, architectures, and the like.

It can be seen from the above-described exemplary mapping arrangement that different VLUNs may contend for access to the same storage device. For example, VLUN2 216 and VLUN4 220 may contend for access to storage device 1 232; VLUN1 214 and VLUN3 218 may contend for access to storage device 2 234; and VLUN2 216 and VLUN3 218 may contend for access to storage device 3 236. The storage virtualization controller arrangement 201 according to an embodiment of the present invention performs the mappings and resolves access contention, while allowing data transfers between the host and the storage device to occur at wire-speed.

Before considering the various elements of the storage virtualization system in detail, it is useful to discuss, with reference to FIGS. 1 and 2, the format and protocol of the storage requests that are sent over SAN 200 from a host to a storage device through the controller arrangement 201. Many storage devices frequently utilize the Small Computer System Interface (SCSI) protocol to read and write the bytes, blocks, frames, and other organizational data structures used for storing and retrieving information. Hosts access a VLUN using these storage devices via some embodiment of SCSI commands; for example, layer 4 of Fibre Channel protocol. However, it should be noted that the present invention is not limited to storage devices or network commands that use SCSI protocol.

Storage requests may include command frames, data frames, and status frames. The controller arrangement 201 processes command frames only from hosts, although it may send command frames to storage devices as part of processing the command from the host. A storage device generally does not send command frames to the controller arrangement 201, but instead sends data and status frames. A data frame can come from either host (in case of a write operation) or the storage device (in case of a read operation).

In many cases one or more command frames is followed by a large number of data frames. Command frames for read and write operations include an identifier that indicates the VLUN that data will be read from or written to. A command frame containing a request, for example, to read or write a 50 kB block of data from or to a particular VLUN may then be followed by 25 continuously-received data frames each containing 2 kB of the data. Since data frames start coming into the controller 203 only after the controller has processed the command frame and sent a go-ahead indicator to the host or storage device that is the originator of the data frames, there is no danger of data loss or exponential delay growth if the processing of a command frame is not done at wire-speed; the host or the storage device will not send more frames until the go-ahead is received. However, data frames flow into the controller 203 continuously once the controller gives the go-ahead. If a data frame is not processed completely before the next one comes in, the queuing delays will grow continuously, consuming buffers and other resources. In the worst case, the system could run out of resources if heavy traffic persists for some time.

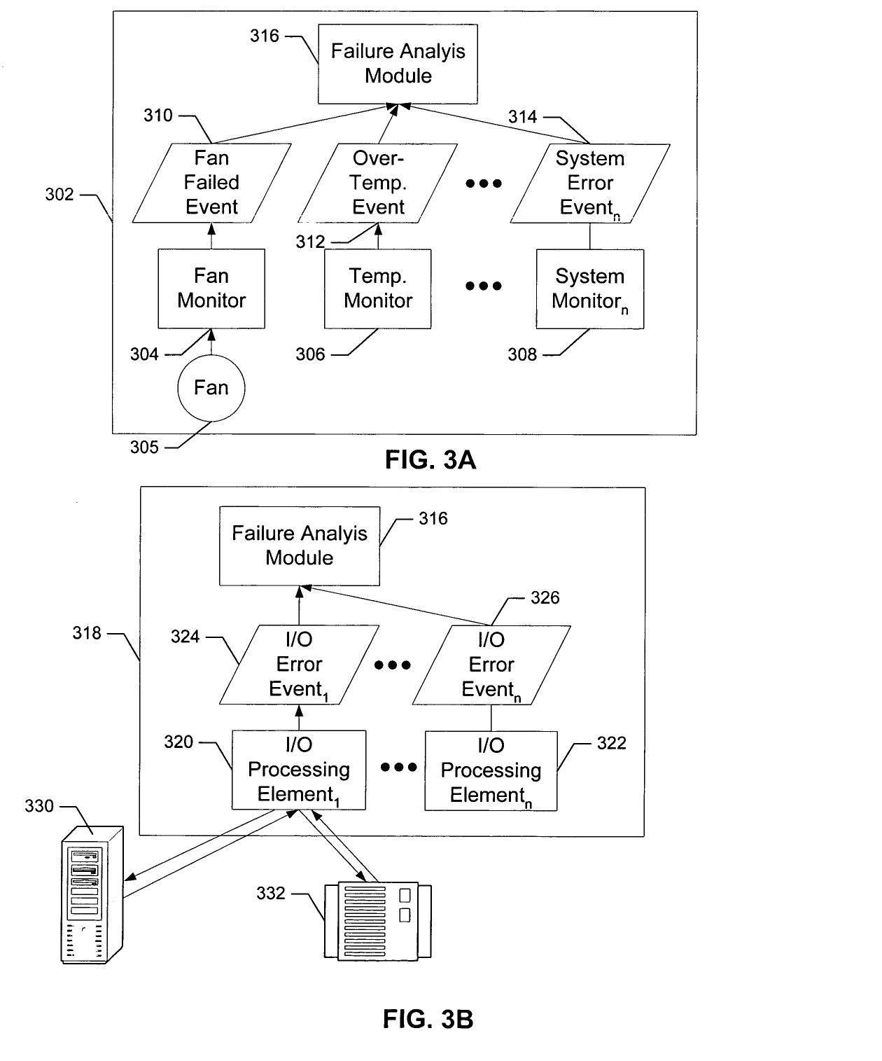

FIG. 3A provides a schematic block diagram in virtualization storage controller 302 for tracking system error events using a failure analysis module in accordance with one embodiment of the present invention. The system error events and failure analysis module are illustrated separately in FIG. 3A for purposes of explanation and clarity but can be combined with other components for tracking other error events as described in further detail later herein. Further, many additional components typically used in virtualization storage controller 302 depicted in FIG. 3A have been omitted to focus on implementations of the present invention rather than details of virtualization storage controller 302.

In this schematic diagram, processing system error events includes a failure analysis module 316, a fan monitor 304, a fan 305, a temperature monitor 306 and up to and including an nth system monitor 308. Further, this example includes a fan failed event 310, an over-temperature event 312 and up to and including an nth system error event 314 responsive to the conditions of components being monitored by corresponding fan monitor 304, temperature monitor 306 and nth system monitor 308. Each identified system error event also has a corresponding error. These system error events represent a set of errors occurring to a module within storage virtualization controller 302.

For example, a fan failure condition or over-temperature condition from modules in storage virtualization controller 302 is monitored by the respective monitors and generate system error events when the condition threshold is met. If fan monitor 304 detects that fan 305 has stopped operating or failed, fan monitor 304 sends a fan failed event 310 to failure analysis module 316. Similarly, if temperature monitor 306 detects that the temperature has exceeded a threshold temperature, temperature monitor 306 also sends over-temperature event 312 to failure analysis module 316. Over time, failure analysis module 316 receives one or more of the system error events and identifies a predetermined error action to take in response as will be described in further detail later herein.

FIG. 3B provides another schematic block diagram for tracking input-output error events by a failure analysis module in virtualization storage controller 302 in accordance with one embodiment of the present invention. Like system error events described previously, these input-output error events are provided separately in FIG. 3B for purposes of explanation and clarity but can be combined with other types of error events as described later herein. Similarly, many additional components typically used in virtualization storage controller 302 depicted in FIG. 3B have been omitted to focus on implementations of the present invention rather than details of virtualization storage controller 302.

In FIG. 3B, storage virtualization controller 302 processes a variety of input-output error events using a failure analysis module 316 in conjunction with an input-output processing element 320 and a range of input-output processing elements up to and including an nth input-output processing element 322. Further, this example includes an input-output error event 324 and a range of input-output error events up to and including an nth input-output error event 326 responsive to communication errors between storage virtualization controller 302 and a server 330 or a storage element 332 in the storage area network. Failure analysis module 316 analyzes input-output communication errors as storage virtualization controller 302 is communicating with server 330 or storage element 332. Compared with system error events described previously, input-output event errors occur during communication between different subsystems of the storage area network and are not limited to events occurring within storage virtualization controller 302.

In one example, server 330 makes a request to read data from storage element 332 that passes through input-output processing element 320 within storage virtualization controller 302. Input-output processing element 320 receives the request and responds by forwarding the request to storage element 332 or any other storage element as specified in the request. Due to some malfunction or other input-output communication error, input-output processing element 320 cannot service the request and provides a “failure condition” back to input-output processing element 320. In SCSI parlance, the error code returned may indicate a “SCSI Check Condition”. Accordingly, input-output processing element 320 responds by generating an input-output error event with codes that failure analysis module 316 parses and analyzes. Failure analysis module 316 also transmits the code corresponding to the input-output error event to server 330. In addition, failure analysis module 316 may also perform an error action in response depends on the number of errors and the type of errors discovered and other factors as described in further detail later herein.

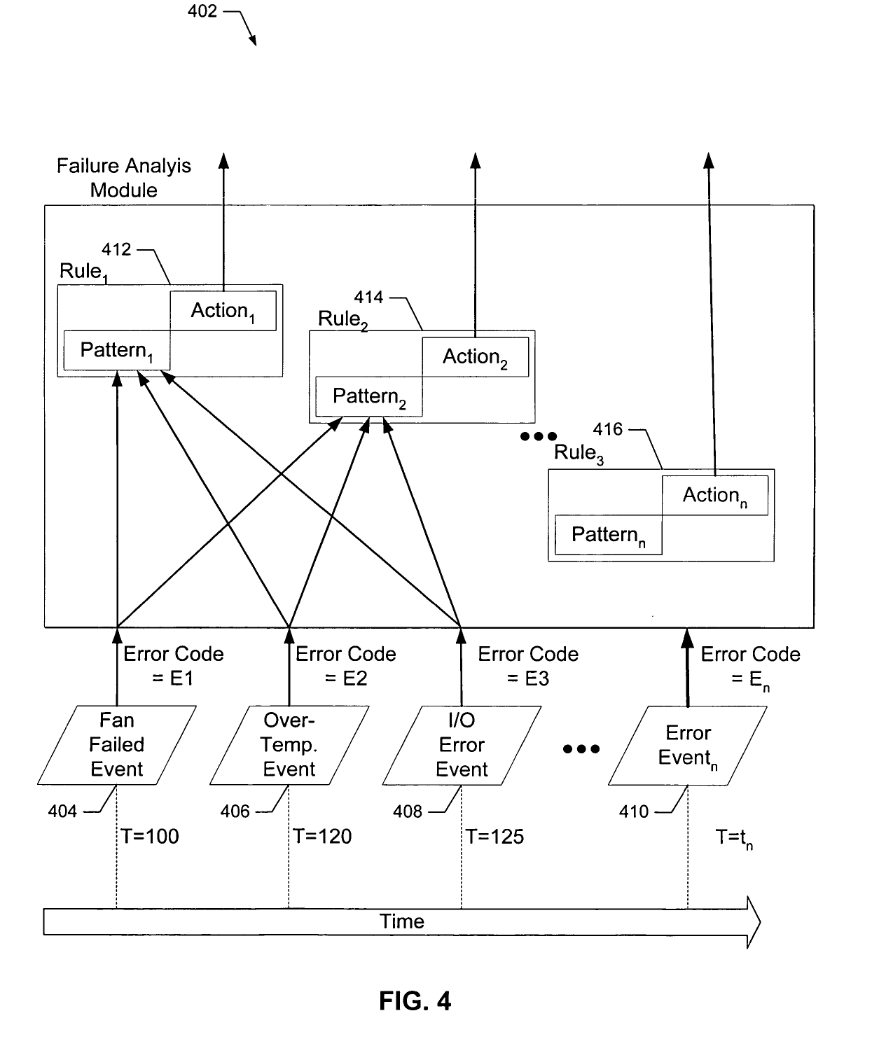

FIG. 4 is a schematic diagram illustrating a combination of system error events and input-output error events and their processing in accordance with one implementation of the present invention. In this example diagram, failure analysis module 403 receives a combination of error types (i.e., both system error events and input-output error events) including fan failed event 404, over-temperature event 406, input-output error event 408 up to and including the nth error event 410. Various monitor modules note the specific timing of the error events and convert the error events into specific error codes capable of further processing by failure analysis module 403. For example, fan failed event 404, over-temperature event 406, input-output error event 408 up to and including the nth error event 410 are converted to error codes E1, E2, E3 and Eₙ at times T=100, T=120, T=125 and T=tₙ, respectively before being passed to failure analysis module 403 for further processing. It should be understood that the number of error events, error patterns or error actions illustrated in FIG. 4 are examples and should not be limited to the number illustrated but instead may be greater or fewer as needed by the particular implementation requirements.

Once received, failure analysis module 403 compares the temporal arrangement of error events against patterns in rule 412, rule 414 up to an including nth rule 416. In one implementation, each rule corresponds to a single action executed when there is a match between the temporal arrangement of error events and the particular pattern associated with the rule. When this occurs, failure analysis module 403 invokes and executes and predetermined error action associated with the rule.

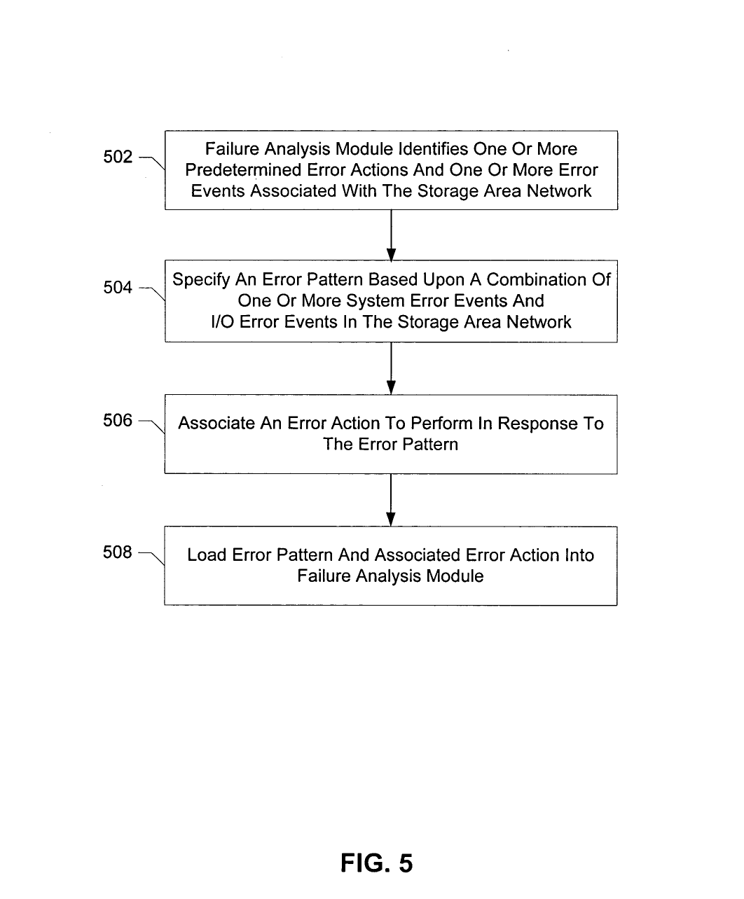

Referring to FIG. 5, a flowchart diagram provides the operations for configuring implementations of the present invention to manage errors in the storage virtualization controller. Initially, a failure analysis module identifies one or more predetermined error actions and one or more error events associated with the storage area network (502). Typically, the predetermined error actions and error events are specified during an initialization or programming of components within the storage virtualization controller. In one implementation, a failure analysis module located within a storage virtualization controller is configured as the primary module for processing error events. Alternate failure analysis modules located in other storage virtualization controllers may act as backups to the primary failure analysis module for high-availability and redundancy. The predetermined error events processed by the failure analysis module include both system error events that occur within the storage virtualization controller as well as input-output error events that occur during communication between the storage virtualization controller and a server or storage element associated with the storage area network

The configuration operation also specifies error patterns in the failure analysis module using a combination of one or more possible error events in the storage area network (504). Each of the error patterns includes timing information about the error events as well as the sequencing or grouping of the error events. In one implementation, the error pattern may specify that the error events occur in a particular sequence and during specific time intervals, or alternatively the error pattern may accept error events that occur in any order within a particular time interval. For example, an error pattern consistent with the latter case may allow error events to occur in any order as long as the error events occur within a 20 millisecond interval.

A further operation during configuration associates an error action to perform in response to receiving the combination of one or more error events as specified by the error pattern (506). In general, the error action performs a set of operations to accommodate or counteract the effects of the one or more error events occurring on the storage area network. For example, an over-temperature error event in a virtual storage controller may invoke an error action that diverts processing to another virtual storage controller and gracefully performs a shutdown on the overheating virtual storage controller to prevent further damage. Once the error action is configured into the failure analysis module, implementations of the present invention then loads the error pattern and associated error action into the failure analysis module to prepare for managing subsequent error events on the storage area network (508).

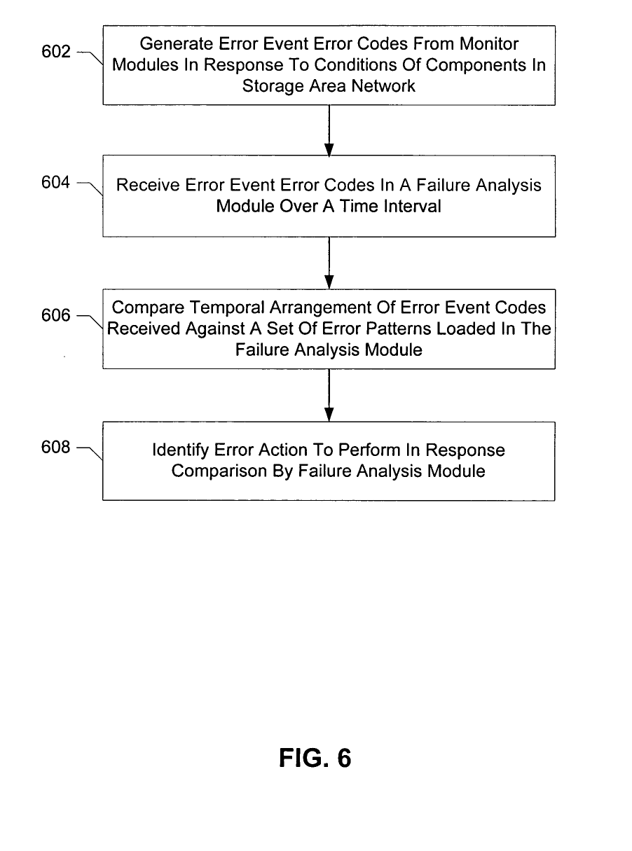

FIG. 6 is a flowchart diagram for managing errors generated in a storage area network in accordance with implementations of the present invention. As a prerequisite, a failure analysis module is preconfigured as described previously with respect to FIG. 5 with information about one or more error events and error actions. In operation, monitor modules associated with the failure analysis module generate error events responsive to conditions occurring on components monitored in the storage area network (602). In one implementation, each monitor modules tracks a particular condition occurring on individual modules in the storage area network or within a storage virtualization controller. For example, a temperature monitor module may monitor for an over-temperature condition in the storage virtualization controller and notify a failure analysis module when this over-temperature event occurs. Typically, the temperature monitor module or other modules will convert the one or more error events from the components in the storage area network into error event codes more readily processed by the failure analysis module.

Instead of a single error event, monitor modules receive multiple error events over a time interval for analysis in the failure analysis module (604). These multiple error events are useful in managing the errors and failures that can occur in complex storage area networks. In some cases, a single error may not be sufficient to invoke an error action unless combined with other types of errors. Alternatively, some errors events may be severe enough (i.e., over-temperature conditions) to warrant immediate execution of error actions and recovery procedures that shutdown one or more components in the storage area network.

Accordingly, in one implementation the failure analysis module compares the temporal arrangement of the error events received against a set of error patterns previously loaded in the failure analysis module (606). The error events can be a combination of system error events and input-output error events and the temporal information can be either the relative timing of the events or an absolute measurement of the timing relative to a clock. Timing and sequencing of these error events are important to determine if the error events warrant taking an error action or other corrective measures. For example, an infrequent error from a storage device may be considered typical while a more frequent and consistent error from a storage device may indicate that a critical failure of the storage device is imminent. As previously described, system error events occur when an error event is detected within the storage virtualization controller while input-output error events correspond to a communication error between the storage virtualization controller and servers or storage elements in the storage area network.

Depending on the actual error events received, the failure analysis module identifies the error pattern from the set of error patterns and the error action corresponding to the error pattern to perform in response to the comparison in the failure analysis module (608). In one implementation, the error patterns are determined in advance and loaded into the failure analysis module during the configuration operations previously described. In most cases, an administrator or operator familiar with operation of the storage area network defines the error patterns based upon their experience and observation of error events over time. Alternatively, error patterns could be generated automatically through extensive logging and analysis of the error events. In this alternate implementation, an operator receives a suggested error pattern generated automatically and then selects an error action to associate with the occurrence of the error pattern.

To avert problems on the storage area network, error actions corresponding to the error patterns can direct the storage virtualization controller to perform a variety of actions to mitigate or recover from the errors. For example, the storage virtualization controller can be instructed to migrate data from a storage element generating error events to other more reliable areas of the storage network not experiencing the error events or failures. Depending on the situation, alternate error actions may direct the storage virtualization controller to migrate data to more reliable RAID type devices rather than a JBOD (just a bunch of disks) device or other less reliable storage options.

In one implementation, an interface to the configuration and management of errors in the present invention is performed using a graphical user interface (GUI) in conjunction with a set of specialized objects developed in an object-oriented language like C++ or Java. The GUI (not illustrated) presents visual information on the various components in the storage area network and the predetermined error events and error actions associated with the components. This error information in the GUI allows an administrator to quickly combine error events into error rules and associate them with error actions to perform by way of the storage virtualization controller in the storage area network. Because the error management and analysis system is rule-driven, the GUI facilitates rapid creation of these rules with pull-down menus and drag-and-drop functionality and other GUI features rather than complex programming languages and development environments. This also enables the management and analysis of errors in the storage area network to evolve over time in response to failures and the detection of error events and conditions. Also, existing rules and error actions can be refined over time as the operating characteristics of the storage area network are discovered. For example, one GUI implementation presents the user with different threshold values for different error events and facilitates associating error actions when such thresholds are crossed. Through the GUI, the user is presented with a pre-determined set of error events and error actions for this purpose and for associating threshold values and error actions for different error events.

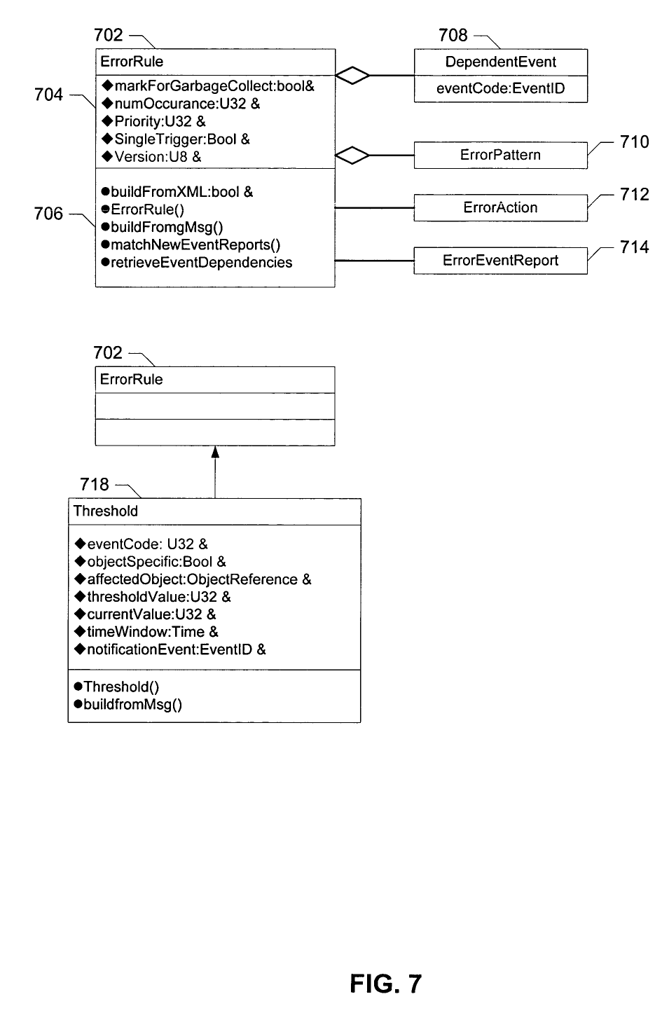

FIG. 7 is a block diagram providing a portion of the object-oriented classes and methods used to implement the error analysis and management of the present invention. An “ErrorRule” class 702 in FIG. 7 includes a set of “ErrorRule” class attributes 704 and “ErrorRule” class methods 706 for operating on instances of the “ErrorRule” class 702. In this example, “ErrorRule” class attributes 704 include “markForGarbageCollect” class attribute to signal that the garbage collector can reclaim an instance of the class, “numOccurrance” class attributes indicates how many times the error action corresponding to this “ErrorRule” was performed. “Priority” class attribute is used to determine a priority of error actions to take for the rule, “SingleTrigger” class attribute is set to true if the error rule is supposed to be performed only once, rather than multiple times, in the entire lifetime of the storage controller and “Version” class attribute is used to identify the version and corresponding features of “ErrorRule” class 702.

“ErrorRule” methods 706 include operations to work with instances of error rule class 702. In this example, “buildFromXML” method is used to create an instance of the “ErrorRule” class from XML, “ErrorRule” method is the “ErrorRule” method itself, “matchNewEventReports” method receives events from event reports to determine if the particular set of error events and their timing match the rule and “retrieveEventDependencies” method retrieves and discloses the error events defined in the particular error rule. It is also important to note that “ErrorRule” class 702 in turn has several other related subclasses namely: “DependentEvent” class 708, “Error Pattern” class 710, “Error Action” class 712 and “Error Event Report” class 714. “Dependent Event” class 708 describes a single event and the corresponding event code outside used when “ErrorRule” class 702 depends on the single event rather than a complex “ErrorPattern” class 710. When the ErrorPattern is formed of a single event rather than a complex pattern, the “DependentEvent” class describes the single event and its event code, forming the “ErrorPattern” class 710. Aside from “DependentEvent” class 708, details on these classes are described in further detail later herein.

“Threshold” class 718 is a subclass of “ErrorRule” class 702 and has “Threshold” class attributes 720 and “Threshold” class methods 722. “Threshold” class identifies error events that occur multiple times before they are acted upon. In this example, “Threshold” class attributes 720 from “Threshold” class 718 includes “eventCode” class attribute that describes error event code for the failure analysis module to process; “objectSpecific” class attribute is a Boolean to indicate whether the error event is specific to a particular object/component or may emanate from any object/component in the storage area network; the “affectedObject” class attribute specifies a pointer or other identifier for a particular object when the “objectSpecific” attribute is set to true; “thresholdValue” class attribute is a number used to measure the frequency of the error event or a measurement value of the error event; “currentValue” class attribute holds the current count of the number of times the error event for this object has been seen within the specified time interval; “timeWindow” class attribute provides a time period from beginning to end to measure threshold amounts and “notificationEvent” class attribute provides an opportunity for others to receive notice and information on the above threshold event.

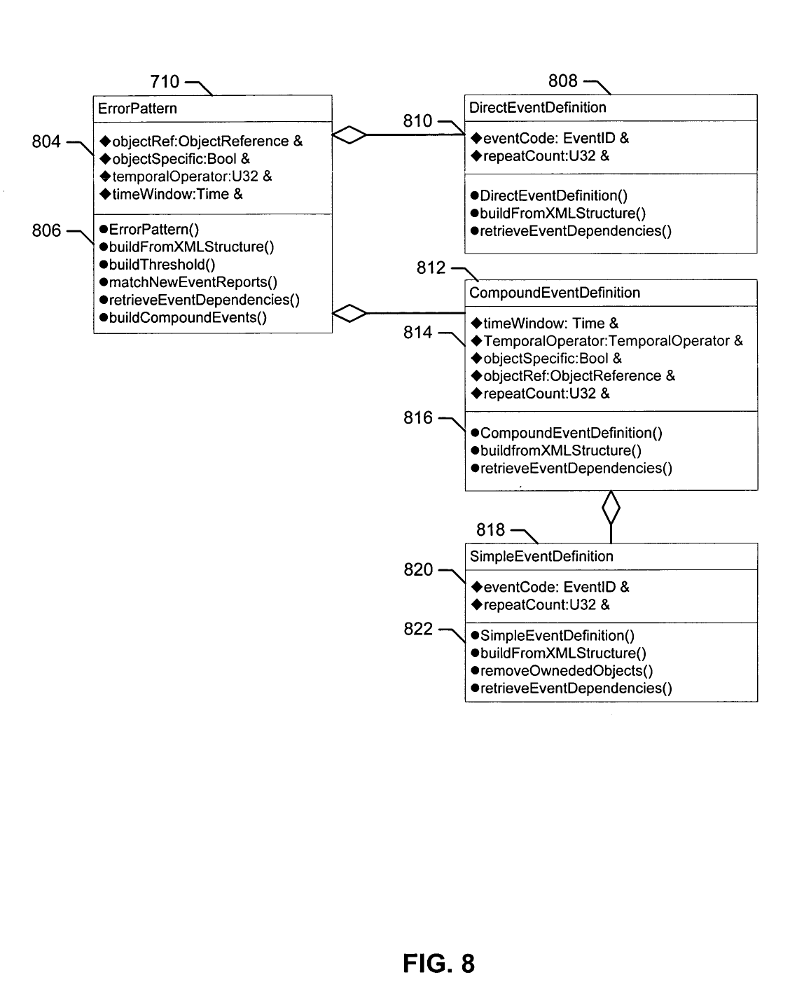

Referring to FIG. 8 are additional classes associated with one implementation of the present invention for creating error patterns. In this example, “Error Pattern” class 710 also includes an “Error Pattern” class attributes 804 section and “Error Pattern” class methods 806 section. In addition to the attributes in other previously mentioned classes, “Error Pattern” class attributes 804 also includes “temporalOperator” class attribute to combine instances of “DirectEventDefinition” class 808 with instances of “CompoundEventDefinitions” class 812 conditioned upon certain temporal or timing characteristics. “ErrorPattern” class methods 806 also include additional class methods “buildThreshold” class method, “matchNewEventReports” class method and “buildCompoundEvents” class method.

In this example, “buildThreshold” class method is used to identify and define the threshold levels for instances of “DirectEventDefinition” class 808, instances of “CompoundEventDefinition” class 812 and “SimpleEvent” class 818; “matchNewEventReports” class method receives event reports generated when errors occur and determines if the new error events have occurred for purposes of matching the “ErrorPattern” class method. The “buildCompoundEvents” class method is a method that combines the various instances of “DirectEventDefinition” class 808, “CompoundEventDefinition” class 812 and “SimpleEventDefinition” class 818 into an instance of “ErrorPattern” class 710 for later comparison and matching.

Referring to “DirectEventDefinition” class attributes 810, an “eventCode” class attribute identifies the particular event and “repeatCount” class attribute determine when sufficient occurrences of the “eventCode” have occurred. Compared with “DependentEvent” class 708, “DirectEventDefinition” class 808 also measures the event frequency measurement as measured by “repeatCount” class attribute.

“CompoundEventDefinition” 812 is yet another class used to combine instances of “SimpleEventDefinition” classes 818. In addition to similar class attributes previously described, “CompoundEventDefinition” class 812 uses an additional “timeWindow” class attribute and “repeatCount” class attribute. In this example, “timeWindow” class attribute specifies a window of time that instances of “SimpleEventDefinition” class 818 are stored in “repeatCount” class attribute in “CompoundEventDefinition” class 812.

“SimpleEventDefinition” class 818 is similar to “DirectEventDefinition” class 808 in that it uses an “eventCode” class attribute and a “repeatCount” class attribute. The difference in this example is that “SimpleEventDefinition” class 818 contributes to “ErrorPattern” class 710 through “CompoundEventDefinition” class 812 while “DirectEventDefinition” class 808 depends directly on “ErrorPattern” class 710.

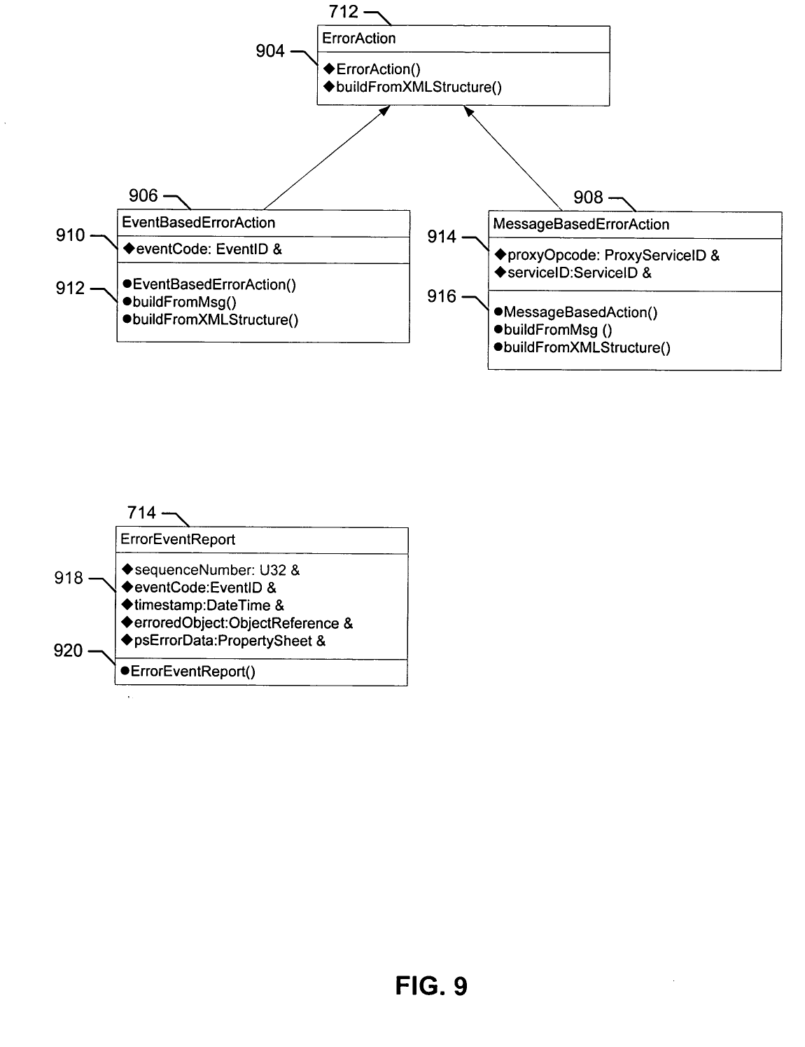

In FIG. 9 are additional object-oriented classes used to further define “ErrorRule” class 702 in accordance with one implementation of the present invention. “ErrorAction” class 712 specifies the operations taken in response to the satisfaction of the error pattern described in an instance of “ErrorPattern” class 710. In this example, “ErrorAction” class 712 includes “ErrorAction” class methods 904 and leaves “ErrorAction” class attributes open for subsequent definition. Subclasses to “ErrorAction” class 712 include an “EventBasedErrorAction” class 906 and a “MessageBasedErrorAction” class 908. In the first case, an instance of “EventBasedErrorAction” class 906 broadcasts to different processes or objects that an instance of “ErrorAction” class 712 is going to be performed while in the second case, an instance of “MessageBasedErrorAction” class 908 is used to communicate the instance of “ErrorAction” class 712 directly with a particular service identified by “serviceID” class attribute. Unlike an “EventBasedErrorAction” class 906, “MessageBasedErrorAction” class 908 instructs the designated service to perform a particular function or opcode specified by “proxyopcode” class attribute. In contrast, services “listening” for an instance of “EvenBasedErrorAction” class 906 decide autonomously which function or functions to perform when “EventBasedErrorAction” class 906 is used to broadcast the event through an interrupt based or other mechanism.

“ErrorEventReport” class 714 is another subclass to “ErrorRule” class 702 and is used to capture descriptive information about each error event. In this example, “ErrorEventReport” class 714 includes “ErrorEventReport” class attributes 918 and “ErrorEventReport” class methods 920. Additional class attributes from “ErrorEventReport” class attributes 918 worth mentioning include “sequenceNumber” class attribute, “erroredObject” class attribute and “psErrorData” class attribute. The “sequenceNumber” class attribute gives a relative sequence of the error compared to other errors in the system; “erroredObject” class attribute is a pointer to the object associated with the component in the storage area network experiencing an error or failure and “psErrorData” class attribute is a catch-all storage area for any additional area that may be of interest. “psErrorData” class attribute is used to store proprietary or specific code information that may be of further assistance in identifying or debugging an error or failure in the storage area network.

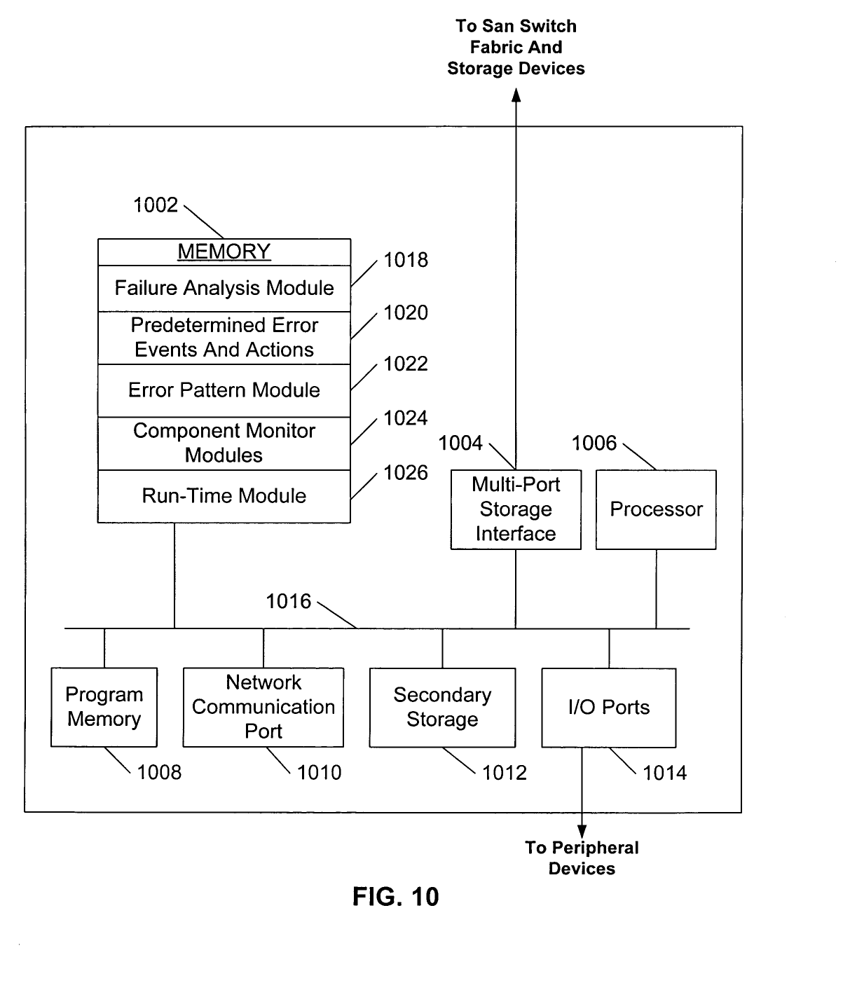

FIG. 10 provides one implementation of the present invention as it would be implemented in a computer device or system. In this example, system 1000 includes a memory 1002, typically random access memory (RAM), a multiport storage interface 1004, a processor 1006, a program memory 1008 (for example, a programmable read-only memory (ROM) such as a flash ROM), a network communication port 1010 as an alternate communication path, a secondary storage 1012, and I/O ports 1014 operatively coupled together over interconnect 1016. The system 1000 can be preprogrammed, in ROM, for example using a microcode or it can be programmed (and reprogrammed) by loading a program from another source (for example, from a floppy disk, a CD-ROM, or another computer) and preferably operates using real-time operating system constraints.

Memory 1002 includes various components useful in implementing aspects of the present invention. These components include a failure analysis module 1018, predetermined error events and error actions 1020, an error pattern module 1022, and component monitor module 1024 managed using a run-time module 1026.

Failure analysis module 1018 is typically included with each storage virtualization controller and provides a centralized error management and analysis in accordance with implementations of the present invention. Multiple failure analysis module 1018 operate in backup capacities to the central or primary failure analysis module 1018 to provide high-availability and redundancy as previously described.

Predetermined error events and error actions 1020 includes a set of predetermined errors and error actions known to occur within a storage area network and stored in a database or other storage area. These predetermined error events and error actions 1020 are combined together to create error rules as previously described and used in the management and analysis of errors in accordance with the present invention. Once the error rules are created, error pattern module 1022 receives the errors and analyzes the results in light of the various error rules. If conditions in the error rules are discovered, an error action is performed to address the error or failure in the storage area network. In one implementation of the present invention, the error pattern module 1024 uses object-oriented programming languages and classes. Component monitor module 1024 is a set of monitor routines that monitors one or more different components within the storage area network and converts the errors into error codes for further processing by other aspects of the present invention. These component monitor module 1024 also can be developed using object-oriented programming languages, classes and principles.

In general, implementations of the invention can be implemented in digital electronic circuitry, or in computer hardware, firmware, software, or in combinations of them. Apparatus of the invention can be implemented in a computer program product tangibly embodied in a machine readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high level procedural or object oriented programming language, or in assembly or machine language if desired; and in any case, the language can be a compiled or interpreted language. Suitable processors include, by way of example, both general and special purpose microprocessors. Generally, the processor receives instructions and data from a read only memory and/or a random access memory. Also, a computer will include one or more secondary storage or mass storage devices for storing data files; such devices include magnetic disks, such as internal hard disks and removable disks; magneto optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto optical disks; and CD ROM disks. Any of the foregoing can be supplemented by, or incorporated in, ASICs (application specific integrated circuits).

While specific embodiments have been described herein for purposes of illustration, various modifications may be made without departing from the spirit and scope of the invention. For example, implementations of the present invention are described as being used by SAN system using distributed storage virtualization controllers however it can also be also be used for tracing functionality on other distributed systems including distributed network controllers, distributed computing controllers, and other distributed computing products and environments. Accordingly, the invention is not limited to the above-described implementations, but instead is defined by the appended claims in light of their full scope of equivalents. From the foregoing it will be appreciated that the storage virtualization controller arrangement, system, and methods provided by the present invention represent a significant advance in the art. Although several specific embodiments of the invention have been described and illustrated, the invention is not limited to the specific methods, forms, or arrangements of parts so described and illustrated. For example, the invention is not limited to storage systems that use SCSI storage devices, nor to networks utilizing fibre channel protocol. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Unless otherwise specified, steps of a method claim need not be performed in the order specified. The invention is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements.

What is claimed is:

1. A method for configuring a storage virtualization controller to manage errors in a storage area network, comprising:
identifying one or more predetermined error actions and one or more error events associated with the storage area network;
specifying an error pattern based upon a combination of one or more error events in the storage area network; and
associating an error action to perform in response to receiving the combination of one or more error events of the error pattern.

2. The method of claim 1 further comprising loading the error pattern and associated error action into a failure analysis module.

3. The method of claim 1 further comprising initializing a failure analysis module with the one or more predetermined error actions, the one or more predetermined system error events and the one or more predetermined input-output error events associated with the storage area network.

4. The method of claim 1 wherein the configuration and management is performed using a centralized failure analysis module.

5. The method of claim 3 wherein the failure analysis module initialized with the one or more predetermined error actions is configured as a primary module for processing error events and alternate failure analysis modules are configured as backups to the primary failure analysis module to facilitate high-availability and redundancy.

6. The method of claim 1 wherein each of the one or more predetermined error actions describes a set of operations to accommodate the occurrence of the one or more system error events and input-output error events.

7. The method of claim 1 wherein the one or more error events are selected from a set of error events including predetermined system error events and predetermined input-output error events.

8. The method of claim 7 wherein each of the one or more system error events occurs when an error event occurs corresponding to a module within the storage virtualization controller.

9. The method of claim 1 wherein each of the one or more input-output error events corresponds to a communication error between the storage virtualization controller and servers or storage elements in the storage area network.

10. The method of claim 1 wherein the error pattern and associated error actions are specified incrementally over time without recoding.

11. The method of claim 1 wherein the error pattern is generated automatically through a logging and analysis of past error events.

12. A method of managing the occurrence of errors generated in a storage area network, comprising:
generating one or more error events responsive to the occurrence of one or more conditions of components being monitored in the storage area network;
receiving the one or more error events over a time interval for analysis in a failure analysis module;
comparing a temporal arrangement of the error events received against a set of error patterns loaded in the failure analysis module; and
identifying the error pattern from the set of error patterns and the error action corresponding to the error pattern to perform in response to the comparison in the failure analysis module.

13. The method of claim 12 wherein the one or more error events are converted into error event codes by a set of monitor modules monitoring the components in the storage area network.

14. The method of claim 12 wherein the one or more error events are selected from a set of error events including predetermined system error events and predetermined input-output error events.

15. The method of claim 14 wherein each of the one or more system error events occurs when an error event occurs corresponding to a module within a storage virtualization controller.

16. The method of claim 14 wherein each of the one or more input-output error events corresponds to a communication error between the storage virtualization controller and servers or storage elements in the storage area network.

17. The method of claim 12 wherein the failure analysis module receiving the one or more error events is configured as a primary failure analysis module for processing error events and alternate failure analysis modules are configured as backups to the primary failure analysis module to facilitate high-availability and redundancy.

18. An apparatus that configures a storage virtualization controller to manage errors in a storage area network, comprising:
a processor capable of executing instructions;
a memory containing instructions capable of execution on the processor that cause the processor to identify one or more predetermined error actions and one or more error events associated with the storage area network, specify an error pattern based upon a combination of one or more error events in the storage area network and associate an error action to perform in response to receiving the combination of one or more error events of the error pattern.

19. The apparatus of claim 18 further comprising instructions in the memory when executed load the error pattern and associated error action into a failure analysis module in the memory.

20. The apparatus of claim 18 further comprising instructions in the memory when executed initialize a failure analysis module with the one or more predetermined error actions, the one or more predetermined system error events and the one or more predetermined input-output error events associated with the storage area network.

21. The apparatus of claim 18 wherein the configuration and management is performed using a centralized failure analysis module.

22. The apparatus of claim 20 wherein the failure analysis module initialized with the one or more predetermined error actions is configured as a primary module for processing error events and alternate failure analysis modules are configured as backups to the primary failure analysis module to facilitate high-availability and redundancy.

23. The apparatus of claim 18 wherein each of the one or more predetermined error actions describes a set of operations to accommodate the occurrence of the one or more system error events and input-output error events.

24. The apparatus of claim 18 wherein the one or more error events are selected from a set of error events including predetermined system error events and predetermined input-output error events.

25. The apparatus of claim 24 wherein each of the one or more system error events occurs when an error event occurs corresponding to a module within the storage virtualization controller.

26. The apparatus of claim 18 wherein each of the one or more input-output error events corresponds to a communication error between the storage virtualization controller and servers or storage elements in the storage area network.

27. An apparatus for managing the occurrence of errors generated in a storage area network, comprising:
a processor capable of executing instructions;
a memory containing instructions when executed on the processor generate one or more error events responsive to the occurrence of one or more conditions of components being monitored in the storage area network, receive the one or more error events over a time interval for analysis in a failure analysis module, compare a temporal arrangement of the error events received against a set of error patterns loaded in the failure analysis module and identify the error pattern from the set of error patterns and the error action corresponding to the error pattern to perform in response to the comparison in the failure analysis module.

28. The apparatus of claim 27 wherein the one or more error events are converted into error event codes by a set of monitor modules monitoring the components in the storage area network.

29. The apparatus of claim 25 wherein the one or more error events are selected from a set of error events including predetermined system error events and predetermined input-output error events.

30. The apparatus of claim 27 wherein each of the one or more system error events occurs when an error event occurs corresponding to a module within the storage virtualization controller.

31. The apparatus of claim 27 wherein each of the one or more input-output error events corresponds to a communication error between the storage virtualization controller and servers or storage elements in the storage area network.

32. The apparatus of claim 25 wherein the failure analysis module receiving the one or more error events is configured as a primary failure analysis module for processing error events and alternate failure analysis modules are configured as backups to the primary failure analysis module to facilitate high-availability and redundancy.

33. An apparatus for configuring a storage virtualization controller to manage errors in a storage area network, comprising:
means for identifying one or more predetermined error actions and one or more error events associated with the storage area network;
means for specifying an error pattern based upon a combination of one or more error events in the storage area network; and
means for associating an error action to perform in response to receiving the combination of one or more error events of the error pattern.

34. An apparatus for managing the occurrence of errors generated in a storage area network, comprising:
means for generating one or more error events responsive to the occurrence of one or more conditions of components being monitored in the storage area network;
means for receiving the one or more error events over a time interval for analysis in a failure analysis module;
means for comparing a temporal arrangement of the error events received against a set of error patterns loaded in the failure analysis module; and
means for identifying the error pattern from the set of error patterns and the error action corresponding to the error pattern to perform in response to the comparison in the failure analysis module.

35. A method for configuring a storage virtualization controller to manage errors in storage area network, comprising:
identifying one or more predetermined error actions and one or more error events associated with the storage area network;
specifying an error pattern based upon a combination of one or more error events in the storage area network, presented through a graphical user interface with corresponding threshold values; and
associating an error action presented through the graphical user interface to perform in response to receiving the combination of one or more error events of the error pattern that satisfy the threshold value requirements.
